(19) United States
(12) Patent Application Publication
(10) Pub. No.: US 2010/0203394 A1
(43) Pub. Date: Aug. 12, 2010

(54) THIN METAL-AIR BATTERIES

(76) Inventors: In Tae Bae, Wrentham, MA (US); Jonathan M. Boulton, North Attleboro, MA (US); Steven J. Specht, Brookfield, CT (US)

Correspondence Address: FISH & RICHARDSON P.C., P.O. BOX 1022, MINNEAPOLIS, MN, 55440-1022, US

(21) Appl. No.: 12/366,795

(22) Filed: Feb. 6, 2009

(51) Int. Cl. H01M 2/16; G08B 21/00

(52) U.S. Cl. 429/246; 340/604; 29/623.1; 29/623.3; 29/623.4; 29/623.5

(57) ABSTRACT

Thin metal-air batteries are described. The batteries do not have an enclosure.

### TECHNICAL FIELD

This invention relates to metal-air batteries, in which air is admitted to a first electrode, normally the cathode, and a second electrode, normally the anode, is oxidized with oxygen from the air.

### BACKGROUND

Batteries or electrochemical cells are commonly used electrical energy sources. A battery, such as metal-air battery, contains a negative electrode, typically called the anode, and a positive electrode, typically called the cathode. The anode can oxidize an active material; the cathode can consume an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

Primary metal-air batteries, such as zinc/air batteries, can deliver a high energy density at a relatively low operating cost. Primary batteries are meant to be discharged (e.g., to exhaustion) only once, and then discarded (e.g., primary batteries are not intended to be recharged). Primary batteries are described, for example, in David Linden, Handbook of Batteries (McGraw-Hill, 2d ed. 1995).

Many applications, such as medical applications (e.g., gastroenterological diagnostic or in vivo sensors) require very small batteries. While there are some primary batteries available in very thin forms, their practical applications are limited by factors originating from their physical dimensions, such as low power, low running capacity, poor storage, and relatively high cost. For example, as a battery is miniaturized, the battery enclosure (e.g., housing) can occupy a relatively large proportion of the battery volume, and the internal volume for the active material becomes smaller, which can lead to a poor energy density. In addition, battery enclosure can present a significant portion of the manufacturing cost for small button cells, such as those used in calculators, wrist watches, or hearing aids.

### SUMMARY

The invention relates to batteries, and to related components, methods, and products that include the batteries. The battery includes an anode layer, a separator layer, and a cathode layer laminated together in the form of an enclosure-less battery. The battery can be thin and have relatively high energy density. The battery is dormant when dry, and can be activated by contacting the battery with water (e.g., liquid water, aqueous solutions including water, and/or water vapors) to provide a current. The battery can provide a current for as long as it is in touch with water or until the electrodes are no longer available for reaction. In some embodiments, the battery is used in water detection, such as leak detection of water (e.g., water, an aqueous solution), or moisture detection of water vapors, and can be used in consumer products (e.g., diapers and pregnancy tests). When used in consumer products, the size of the consumer products can be reduced, as volume required for the thin battery is relatively small (e.g., as small as 0.01 cubic centimeter).

In general, the battery includes an anode including zinc, aluminum, magnesium; a cathode including an oxygen reduction catalyst on an electrically conducting porous substrate; and a dry separator disposed between the anode and the cathode. The cathode can include more than one oxygen reduction catalyst. The dry separator can include a hydrophilic membrane, a hydrophilic membrane and at least one salt, or an ion exchange membrane with or without salt. The anode, cathode, and separator are joined together to form a layered battery, and the anode, cathode, and separator are not further enclosed within the layered battery.

In one aspect, the invention features a battery including a layered assembly of the anode, the cathode, and the separator. When assembled, the anode, cathode, and separator are not further enclosed within the layered battery.

In another aspect, the invention features a method of making the battery.

In another aspect, the invention features a method of using the battery, including contacting the battery with a liquid sample.

In yet another aspect, the invention features a consumer product including water detector, such as a moisture detector or a leak detector, including the battery.

Embodiments can include one or more of the following features.

In some embodiments, the anode is porous. The anode (e.g., a foil) can be perforated, woven, compressed nonwoven, screened, meshed, porous, or in the form of a foam. The anode can be in direct contact with the separator.

In some embodiments, the oxygen reduction catalyst is on one or both sides of the porous substrate (e.g., a perforated porous substrate). The oxygen reduction catalyst can be further supported on one or more materials, such as a high surface area material (e.g., carbon-black, graphite, charcoal, and/or activated carbon). In some embodiments, the oxygen reduction catalyst is directly impregnated in the porous layer.

In some embodiments, the hydrophilic membrane includes an ion exchange membrane. In some embodiments, the salt is impregnated into the hydrophilic membrane, which can be used as the separator. In some embodiments, the hydrophilic membrane includes polyethylene oxide, paper, polyacrylic acid, polyvinyl alcohol, gelatin, starch, agar, composites thereof, blends thereof, and/or combinations thereof. The hydrophilic membrane can be a free-standing film and/or can include a salt.

In some embodiments, the separator has an edge that can be sealed with a water-impermeable material. In some embodiments, the separator includes an ion exchange membrane, which can provide a solid polymer electrolyte when contacted with water.

In some embodiments, the battery further includes an adhesive material disposed between the anode, the cathode, and the separator. The adhesive can include a cellulose-based hydrophilic material. The adhesive can further include a salt.

In some embodiments, the battery is activated when wetted with water. The water can include liquid water, aqueous solutions, and water vapors. The battery can be a moisture detector (e.g., a humidity detector for detecting water vapors). For example, in some embodiments, the separator includes one or more hygroscopic materials or a blend of hygroscopic materials, such as lithium chloride and/or potassium acetate. The hygroscopic material can absorb moisture and the battery can be activated upon exposure to an ambient environment that includes moisture. The hygroscopic materials can be selected to respond to different relative humidity levels. In some embodiments, the battery is a leak detector for detecting liquid water and/or aqueous solutions.

In some embodiments, contacting the battery with the liquid sample provides an electrolyte. The liquid sample can include water (e.g., water, an aqueous solution including water, water vapors). Contacting the battery with the liquid sample can provide a current that can be maintained while the battery stays contacted with the liquid sample. The battery can be used in disposable or single-use devices.

The consumer product can be a diaper, a pregnancy test, a water detector such as a moisture-detector and/or a leak detector. The water detector can include a wireless communication device, which can be powered by the battery. Water detection can occur remotely through wireless transmission.

Embodiments can include one or more of the following advantages.

The battery can have relatively high energy density. The battery can be disposable, non-toxic, and environmentally friendly. The battery can have a long shelf-life when dormant, and can be activated when necessary by contacting water. In some embodiments, the battery is activated more than once. The battery, when contacted with water, can have simultaneous water-detecting and battery-activation. The battery can be relatively thin, does not include an enclosure (e.g., a housing), and can be amenable to water detection, medical applications, and household applications. When the battery is constructed with non-toxic materials, it can be used in applications where contact with a live subject (e.g., a human subject, an animal subject) is necessary. Further, the battery can be relatively easily and/or inexpensively manufactured.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic cross-sectional view of an embodiment of a metal-air battery;

FIG. 2 is a schematic cross-sectional view of an embodiment of an electrode of a metal-air battery;

FIG. 3 is a schematic cross-sectional view of an embodiment of a metal-air battery;

FIG. 4 is a photograph of an embodiment of a metal-air battery;

FIG. 5 is a graph showing a steady-state voltage to current measurement of an embodiment of a metal-air battery;

FIG. 6 is a photograph of an embodiment of a metal-air battery;

FIG. 7 is a graph showing voltage and current measurements of an embodiment of a metal-air battery;

FIG. 8 is a photograph of a LED powered by an embodiment of a metal-air battery; and

FIG. 9 is a photograph of a LED powered by an embodiment of a metal air battery.

### DETAILED DESCRIPTION

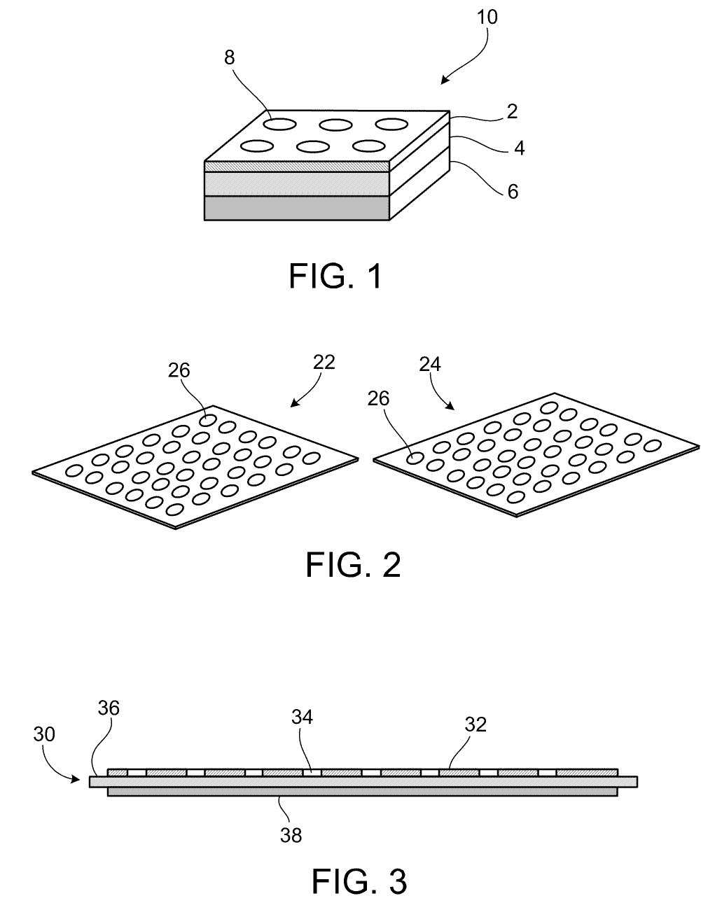

Referring to FIG. 1, a metal-air battery 10 having a three-layer construction is shown. The three layers include an anode 2, a separator 4, and a cathode 6 laminated together in the form of a thin sheet, without any enclosure (e.g., a case, a housing). The separator is disposed between the anode and the cathode, and can directly contact the anode and the cathode. The battery can be dormant, and can include one or more salts coated onto and/or impregnated in the separator. One or both of the electrode layers can be perforated or porous, and the battery can be activated when it is contacted with a sample including water (e.g., water, an aqueous solution including water, water vapor) such that the separator becomes wet and/or ionically conductive. The sample can include a biological fluid (e.g., a fluid secreted by a living organism), such as urine, saliva, sweat, blood, plasma, etc.

### Electrochemical Reactions

Without wishing to be bound by theory, it is believed that in metal air batteries, such as a zinc-air battery, the zinc is discharged as follows:

Zn→Zn²⁺+2 electrons, in acidic solutions;

Zn+2H₂O→Zn(OH)₂+2H⁺+2 electrons, in neutral solutions; or

Zn+4OH⁻→Zn(OH)₄²⁻+2 electrons, in alkaline solutions.

Zinc oxides and zinc hydroxides are amphoteric. In certain neutral media, it is believed that the anode reaction can cease when an insoluble, non-conducting passive film builds on the zinc surface such that zinc ion migration is substantially reduced. When a neutral solution of a salt including an anion Aⁿ⁻ is used, the discharge equation can be represented by:

Zn+Aⁿ⁻→ZnA₂₋ₙ+2 electrons, where n is 1, 2, or 3.

While ZnA₂₋ₙ can be generally insoluble, in some embodiments, the precipitated layer of ZnA₂₋ₙ remains ion-conductive and the Zn anode can continually discharge as long as Aⁿ⁻ migrates from the solution to the zinc surface.

On the cathode, oxygen can be reduced:

O₂+4H⁺+4 electrons→2H₂O, in acidic solutions; or

O₂+2H₂O+4 electrons→4OH⁻, in neutral or alkaline solutions.

As oxygen reduction is generally slower than zinc discharge, to accelerate the reaction, one or more catalysts can be dispersed in a porous oxygen diffusion electrode.

Thus, the overall electrochemical reaction in a zinc-air cell is:

2Zn+O₂+4H⁺→2Zn²⁺+2H₂O, in acidic solutions;

2Zn+O₂+2H₂O→2Zn(OH)₂ (or 2ZnO.H₂O), in neutral solutions; or
2Zn+O₂+4OH⁻+2H₂O→2Zn(OH)₄²⁻, in alkaline solutions.
   Depending on the hydroxide concentration and electrolyte availability in alkaline solutions, ZnO.H₂O can precipitate by:

Zn(OH)₄²⁻→ZnO.H₂O+2OH⁻.

The overall reaction can be analogous to the reaction in neutral solutions. Therefore, in some embodiments, the zinc-air system is discharged irrespective of the nature of the electrolytes.

In some embodiments, the battery includes aluminum-air chemistry. The overall reaction of an aluminum-air cell can be as follows:

4Al+3O₂+12H⁺→4Al³⁺+6H₂O, in acidic solutions;

4Al+3O₂+6H₂O→4Al(OH)₃, in neutral solutions; or

4Al+3O₂+6H₂O+4OH⁻→4Al(OH)₄⁻, in alkaline solutions.

The reaction in alkaline media can be similar to that in neutral media.

In some embodiments, Zn discharges faster than Al in weakly acidic solutions (e.g., pH 4-5), while Al discharges faster than Zn in basic solutions (e.g., pH 10-12). For short term and/or disposable applications, gassing can be of minimal importance and can have relatively little effect on the battery performance.

In some embodiments, the battery includes magnesium-air chemistry. The overall reaction of a magnesium-air cell can be as follows in neutral or alkaline solutions:

Anode: 2Mg+4OH⁻→2Mg(OH)₂+4e⁻,

Cathode: O₂+2H₂O+4e⁻→4OH⁻,

Overall: 2Mg+O₂+2H₂O→2Mg(OH)₂.

In alkaline solutions having pH greater than or equal to 11, the discharge reaction can be limited to the surface of Mg, as Mg(OH)₂ can remain as an inactive passive film.

In acidic solutions, the overall reaction of a magnesium-air cell can be represented by:

Anode: 2Mg→2Mg²⁺+4e⁻;

Cathode: O₂+4H⁺+4e⁻→2H₂O;

Overall: 2Mg+O₂+4H⁺→2Mg²⁺+2H₂O.

### Batter Components, Constructions, and Use

As shown in FIG. 1, the battery 10 includes an anode that is perforated with apertures 8 (e.g., openings 8), which can allow an aqueous solution to reach the separator and thereby activate the battery. The anode can be in a variety of forms, so long as aqueous solutions can pass through and reach the separator, and can be continuous and electrically conducting. For example, the anode can be in the form of a sheet, a foil, or a layer. Anode 2 can include an active material that can be discharged in aqueous electrolytic solutions, such as aluminum, zinc, and/or magnesium. The aluminum, zinc, and/or magnesium can include pure aluminum, zinc, magnesium, and their alloys with other components. In some embodiments, the sheet, foil, or layer is formed entirely of the active material (e.g., a zinc foil, an aluminum foil, or a magnesium foil). In some embodiments, the active material is in the form of a powder and can be coated onto a substrate as a slurry. The slurry can include one or more additives, such as a binder and/or a conductive material. In some embodiments, an additional inactive anode layer serves as a current collector and can be placed on or plated onto an active anode metal.

The conductive material can include carbon particles. Examples of carbon include Black Pearls 2000 (Cabot Corp., Billerica, Mass.), Vulcan XC-72 (Cabot Corp., Billerica, Mass.), Shawinigan Black (Chevron, San Francisco, Calif.), Printex, Ketjen Black (Akzo Nobel, Chicago, Ill.), and Calgon PWA (Calgon Carbon, Pittsburgh, Pa.).

Examples of binders include polyethylene powders, polyacrylamides, Portland cement and fluorocarbon resins, such as polyvinylidene fluoride and polytetrafluoroethylene. An example of a polyethylene binder is sold under the tradename Coathylene HA-1681 (Hoechst). A preferred binder includes polytetrafluoroethylene (PTFE) particles. Generally, the cathode mixture includes between about 10% and 40%, preferably between about 30% and about 40%, of binder by weight.

The anode slurry mixture is formed by blending the active material, carbon particles and binder, and is then coated on a current collector, such as a metal mesh screen, to form a coated substrate. The coated substrate can be dried and calendered to provide the anode.

The anode can be relatively thin. For example, the anode can have a thickness of between 0.005 mm and one millimeter (e.g., between 0.01 mm and one millimeter, between 0.05 and one millimeter, between 0.01 and 0.5 mm, between 0.01 and 0.3 millimeter). In some embodiments, the anode has a thickness of at most one millimeter (e.g., at most 0.07 mm, at most 0.5 mm, at most 0.3 mm, or at most 0.1 mm) and/or at least 0.005 mm (e.g., at least 0.05 mm, at least 0.1 mm, at least 0.3 mm, or at least 0.5 mm). The anode can be rolled between rollers to achieve a desired thickness prior to battery assembly.

Cathode 6 includes one or more oxygen reduction catalysts. For example, the oxygen reduction catalyst can include fine particles of noble metals such as platinum, gold, silver, palladium, other platinum family metals, transition metal oxides, supported transition metal porphyrins, phthalocyanines, polymerized porphyrins and/or phthalocyanines, pyrolyzed products of the above, perovskites, and/or cobalt salt pyrolyzed with polyacrylonitrile (Co-PAN). The metals can include pure metal and their alloys with other components. The catalyst can be supported on a high surface area conducting material, such as carbon black, graphite, charcoal, activated carbon, and/or blended with a hydrophobic binder (e.g., Teflon).

In some embodiments, the catalyst or catalyst composition is applied (e.g., by spraying, brushing, spreading, ink-printing, painting, and/or spin-coating) onto one or both sides of a substrate (e.g., a current collector, such as a carbon/graphite-containing fiber cloth, a carbon/graphite-based fiber cloth, or a metal screen). In some embodiments, the cathode is only coated with the catalyst on the side that is not facing the separator, such that maximum exposure of the catalyst to air is achieved. The coating and/or the current collector can be porous. After application of the catalyst, the coated current collector can be calendared and/or dried. In some embodiments, the catalyst is impregnated in the current collector.

In some embodiments, the cathode includes one or more oxygen reduction catalysts at a loading of at least 0.05 mg/cm² (e.g., at least 0.1 mg/cm², at least one mg/cm², or at least three mg/cm²) and/or at most five mg/cm² (e.g., at most three mg/cm², at most one mg/cm², or at most 0.1 mg/cm²).

In some embodiments, the cathode is relatively thin. For example, the cathode can have a thickness of at most one mm (e.g., at most 0.7 mm, at most 0.5 mm, at most 0.3 mm, or at most 0.1 mm) and/or at least 0.05 mm (e.g., at least 0.1 mm, at least 0.3 mm, or at least 0.5 mm). In some embodiments, the cathode has a thickness of between 0.05 and one mm (e.g., between 0.05 and 0.7 mm, between 0.1 and 0.5 mm, between 0.3 and 0.5 mm, or between 0.05 and 0.5 mm).

In some embodiments, separator 6 is substantially dry, such that the separator has a resistivity value of more than 10⁹ ohm·cm so as to minimize leakage current. For example, for a dry separator having a thickness of 10 microns and an area of one cm², the resistance can be larger than 10⁶ ohm. The separator can include one or more of materials, such as paper pulp, paper, polyethylene oxide, polyacrylic acid, polyvinyl alcohol, gelatin, agar, starch, cellulose-based hydrophilic materials, composites thereof, and/or blends thereof. The one or more materials can include their derivatives. The separator material can be hydrophilic, can be a free standing membrane or film, and/or can be impregnated with one or more salts. In some embodiments, in addition to or instead of the salts and/or the separator materials, the separator includes an ion exchange membrane, which becomes a solid polymer electrolyte when contacted with water.

In some embodiments, the separator is a paper or polymer membrane that can be hydrophilic. The separator can be made by casting a solution including the separator material on a substrate, drying the solution to provide a membrane, and removing the membrane from the substrate. In some embodiments, the separator includes one or more layers of separator materials, and the layers can be the same or different.

The separator can include one or more salts. In some embodiments, the salts include potassium, sodium, calcium, ammonium and/or zinc salts of chloride, nitrate, sulfate, bisulfate, phosphate, phosphate-monobasic, phosphate-dibasic, borate, carbonate, bicarbonate, phthalate, and/or acetate. For applications that require skin contact, non-toxic salts, such as certain bicarbonates, borates, phthalates, acetates, phosphates (mono- or di-basic) can be used. In some embodiments, the salts include hygroscopic salts such as lithium chloride, potassium acetate, potassium nitrate, sodium nitrate, calcium chloride, potassium fluoride, zinc nitrate, and potassium carbonate.

The separator can be impregnated with the one or more salts by immersing a free-standing membrane of the separator into one or more salt solutions for a suitable duration. For example, the separator can be soaked in the one or more salt solutions until the separator has equilibrated with the solutions. In some embodiments, the salt solution is directly applied (e.g., sprayed, brushed, poured) onto the membrane and dried. In some embodiments, the separator material is dispersed in the salt solution or a salt can be dissolved in a pre-prepared polymer solution or polymer dispersion. The mixture can then be cast as a film and dried to remove any residual moisture or solvent.

In some embodiments, the separator includes a salt at a loading of at least 10⁻⁵ mol/cm² (e.g., at least 5×10⁻⁵ mol/cm², at least 10⁻⁴ mol/cm², or at least 5×10⁻⁴ mol/cm²) and/or at most 10⁻³ mol/cm² (e.g., at most 5×10⁻⁴ mol/cm², at most 10⁻⁴ mol/cm², or at most 5×10⁻⁵ mol/cm²).

The separator can be relatively thin. For example, the separator can have a thickness of between 0.05 mm and one millimeter. For example, the separator can have a thickness of at most one mm (e.g., at most 0.7 mm, at most 0.5 mm, at most 0.1 mm, or at most 0.05 mm) and/or at least 0.01 mm (e.g., at least 0.05 mm, at least 0.1 mm, at least 0.5 mm, or at least 0.7 mm). In some embodiments, the separator has a thickness of between 0.01 and one mm (e.g., between 0.01 and 0.7 mm, between 0.1 and 0.5 mm, between 0.3 and 0.5 mm, or between 0.05 and 0.5 mm).

In some embodiments, the separator has a larger area than the overlapping area between anode and the cathode, such that the anode and the cathode are fully physically separated from each other. A larger separator can decrease the likelihood of short circuit between the anode and the cathode. In some embodiments, one or more edges of the separator are sealed with a water-impermeable material (e.g., a water impermeable polymer, a water-impermeable tape). A separator having one or more sealed edges can retain water for a longer period of time than a separator without the one or more sealed edges.

Referring to FIG. 2, in some embodiments, an electrode 22 (e.g., the anode or the cathode) and/or a separator 24 includes one or more openings 26. For example, the anode, cathode, and/or the separator can each be independently porous, perforated, woven, compressed non-woven, screened, meshed, or in the form of a foam. The openings can control liquid access to the separator and the total exposed area of the separator. The opening size and density is not limited. Rather, the size and density of the openings can be selected to control activation time and discharge rate capability of the battery. In some embodiments, the side of the battery containing the openings faces a source of water to enhance the likelihood of activation upon moisture exposure.

In some embodiments, both the anode and the cathode are solid layers and do not include any openings. A liquid can be introduced to the separator along one or more edges of the separator, for example, through capillary action of the liquid in the separator. In some embodiments, the electrodes and/or the separator include one or more porous regions including minute channels that can allow a liquid to permeate throughout the separator. In some embodiments, one or more gaps are present between one or both of the electrodes and the separator. The one or more gaps can allow a liquid to flow to the separator. In some embodiments, the battery and/or its components (e.g., the electrodes, the separator) include encapsulated pockets of water, which can be released to permeate the separator. For example, water can be encapsulated within hydrophobic silica beads, or can be stored in a storage bag or compartment, which can be punctured and connected to the battery when activation is needed.

In some embodiments, one or more of the anode, cathode and separator further include a coating of one or more adhesive on one or more sides. For example, a water-based adhesive for the separator and electrodes include polyvinyl alcohol, polyacrylic acid, polyethylene oxide, gelatin, agar, cellulose-based hydrophilic materials such as starch, and/or their blends. As an example, the anode can include a coating of an adhesive on a side facing the separator, the separator can include a coating of an adhesive on both sides, and/or the cathode can include a coating of an adhesive on a side facing the separator.

During assembly, the anode, separator, and cathode layers are stacked sequentially such that the anode and the cathode are spaced by the separator and not in direct contact with each other. The stacked layers are then laminated (e.g., joined) together to form a single sheet. Lamination conditions can depend on the material of the separator. For example, a polyethylene oxide-based separator can be laminated with both an anode and a cathode by pressing the stacked layers together at a temperature of between about 50 to 70 degrees Celsius. In some embodiments, a solution or slurry including separator material(s) and the salt is cast onto the anode and/or the cathode, and the electrodes can be laminated (e.g., joined) together while the separator material is wet. In some embodiments, the salt is dissolved in an adhesive-containing solution, such as a cellulose-based hydrophilic adhesive, brushed onto both sides of the separator (e.g., a porous paper), which is then placed between the cathode and the anode to provide a single-sheet battery. In some embodiments, the adhesive-containing solution including the salt is coated onto a surface of the cathode and/or the anode contacting the separator, and adhered onto the separator to provide a single-sheet battery. The adhesive can be a hydrophilic adhesive.

In some embodiments, after lamination is complete, the battery is dried in an oven, in a desiccator, and/or under vacuum. Drying can occur at an elevated temperature, for example, between 40-80 degrees Celsius (e.g., 40-60 degrees Celsius, 60-80 degrees Celsius), between 100-120 degrees Celsius (e.g., 100-110 degrees Celsius, 110-120 degrees Celsius), at 60±20 degrees Celsius, or at 110±10 degrees Celsius.

Referring to FIG. 3, when assembled, battery 30 has an electrode 32 having openings 34 (e.g., an anode), a counter-electrode 36 (e.g., a cathode), separated by separator 38. The battery does not have an enclosure (e.g., the battery is enclosure-less), and the separator can be larger than the overlap area between the electrodes, such that battery has a protruding separator edge 38. The assembled battery can be relatively thin. In some embodiments, the battery has a thickness of at most two millimeters (e.g., at most 1.5 millimeters, at most one millimeter, or at most 0.5 millimeter) and/or at least 0.15 millimeter (e.g., at least 0.5 millimeter, at least one millimeter, or at least 1.5 millimeters). For example, the battery can have a thickness of between 0.15 and two millimeters (e.g., between 0.15 and 1.5 mm, between 0.5 and one mm, or between 0.5 and 1.5 mm). The battery can have a relatively small volume. For example, the battery can have a volume of as little as 0.01 cubic centimeters (e.g., as little as 0.05 cubic centimeters, or as little as 0.1 cubic centimeters).

In some embodiments, the battery is flexible and is amenable to applications where a folded, wrapped, curved, or bended battery is desirable. For example, the battery can be amenable to use on skin (e.g., of a live subject), clothing, or diapers. The battery can have a long shelf life of up to several years, or for as long as the battery is kept dry, and can be activated only when necessary by contacting the battery with water.

During use, the battery can be contacted with water, such that the dry separator including the one or more salts absorbs water, becomes ionically conductive, and the coupled electrochemistry between the anode and cathode becomes active. An external current flow can be established. Hence, in some embodiments, the dormant battery is both a water detector and power supply when activated. The battery can function for as long as water contact to the separator is maintained, such that there is ionic conductivity between the anode and the cathode. In some embodiments, the battery is activated more than once. For example, the battery can dry in between exposures to water, while substantially maintaining performance. However, in some embodiments, multiple activations may decrease battery performance. Without wishing to be bound by theory, it is believed that battery performance can degrade on multiple activations due to buildup of reaction products and increase in internal resistance.

In some embodiments, the battery has a nominal voltage of at least 1.10 V (e.g., at least 1.2 V, at least 1.3 V, at least 1.4 V) and/or at most 1.5 V (e.g., at most 1.4V, at most 1.3V, at most 1.2V). An operating voltage can depend on a current load. In operation, the battery can be placed in series or in parallel.

Depending on a rate requirement for a particular application, runtime (e.g., activation period), type of salt, salt concentration in the separator, electrode thickness, catalyst concentration, opening extent and spacings, and electrochemistry can be individually chosen or adjusted. For example, in some embodiments, a salt that can provide a highly conductive electrolyte when contacted with water, such as an electrolyte having a high concentration and having an elevated or very low pH, is more suitable for high rate applications. In some embodiments, when the battery is in contact with a live subject, the separator can include a salt that generates a weakly acidic or basic electrolytic solution, or a neutral solution. In some embodiments, the separator does not include salts. Instead, the aqueous solution that contacts the separator can include sufficient salts to serve as an effective electrolyte for the battery. The amount of solution and the concentration of electrolytes in the aqueous solution can affect the performance of the battery and the response time. In some embodiments, disposable applications having a short runtime are made more cost effective by making relatively thin batteries having small surface areas using inexpensive materials.

In some embodiments, the battery has a relatively high energy density, and can deliver a current as long as the battery is in contact with water and/or when reactive anode active material is available. For example, when contacted with neutral aqueous solutions, the battery can deliver a current until the reactive anode active material becomes unavailable upon substantial formation of a non-conducting passive film on the anode surface, or until the separator is dry, whichever occurs first. In some embodiments, formation of the passive film does not influence the battery performance for its intended purpose. For example, when a power source is needed for a relatively short duration (e.g., between one and ten minutes, between one and six minutes, between one and three minutes).

In some embodiments, the battery is used in water detection, such as in leak detection applications to detect liquid water or solutions. Generation of a current upon contact with water can be used as a signal to detect a liquid water or solution. For liquid detecting or leak detection, strongly hygroscopic salts can increase the likelihood of self-discharge by absorbing moisture from the ambient environment before liquid/solution leakage occurs. Therefore, in some embodiments, for leakage detection purposes, the battery includes weakly hygroscopic salts or non-hygroscopic salts.

In some embodiments, the battery is used in water detection, such as in moisture (e.g., water vapor) detection applications or humidity detecting applications. One or more hygroscopic salts can be used in the battery for moisture or humidity detecting. Examples of hygroscopic salts include lithium chloride, potassium acetate, potassium nitrate, sodium nitrate, calcium chloride, potassium fluoride, zinc nitrate, and potassium carbonate. The hygroscopic salts can absorb moisture and the battery can be activated upon exposure to an ambient environment that includes moisture. The hygroscopic salts can be selected to respond to different relative humidity levels. Hygroscopic salts can decrease the likelihood of evaporation of solution in an activated battery. For example, potassium acetate and lithium chloride can maintain the water content in a wet separator for a relatively lengthy duration, unless the ambient relative humidity drops to below about 20%. The battery can continue to function for as long as the battery remains wet, until consumption of the anode active materials, or until an anode active material becomes unavailable. In some embodiments, the separator includes one or more hygroscopic materials or a blend of hygroscopic materials, such as lithium chloride and/or potassium acetate.

In some embodiments, the battery is used as part of a water detector (e.g., a moisture detector or a leak detector) in a consumer product. The water detector can be used in construction settings (e.g., when placed at locations susceptible to leaks), in households (e.g., on plumbing), in health care (e.g., embedded in diapers, in bandages). In some embodiments, the battery is in direct contact with a subject and can, for example, report the presence of any biological fluid (e.g., on or near a wound) by generation of a current. In some embodiments, the current produced by the current powers a wireless communication device located on a leak detector/moisture detector, which can transmit the presence of moisture to a remote computer or device.

In some embodiments, the battery is used as a power source in applications requiring disposable or single energy sources, such as disposable medical devices (e.g., a pregnancy test, a blood sugar monitor), or for devices for drug delivery through the skin of a live subject.

### EXAMPLES

### Example 1

### Enclosure-Less Battery

Enclosure-less batteries were constructed as follows:

For the anode, a Zn foil (Alfa Aesar, Inc.) was rolled by squeezing the foil between two stainless steel rollers until the thickness reached about 0.1 mm. ⅛″ diameter perforations were made at a density of three holes per cm². The perforated Zn foil was cut into 0.75″×1.25″ rectangles having protruding tabs measuring 0.25″×0.5″ inches.

For the cathode, Co-PAN catalyst powder was prepared as described in S. Gupta, D. Tryk, I. Bae, W. Aldred and E. Yeager, (1989) J. Applied Electrochem. Vol. 19, p. 19-27. The catalyst powder was mixed with a Teflon dispersion (T30B, DuPont) at 40% Teflon by weight and diluted with isopropyl alcohol for easy spreading on a hydrophobic non-woven graphite paper (E-TEK). The catalyst mixture was sprayed onto one side the graphite paper at a loading density of 0.5 mg/cm². After drying, the resulting paper was about 0.1 mm thick, and was cut into the approximately same size as the zinc electrodes.

For the separator, a 4% by weight solution of polyethylene oxide (PEO) was prepared by dissolving PEO (average molecular weight ˜1,000,000, Aldrich Chemical Co.) in water. Potassium phosphate-monobasic salt was added to the PEO solution until a 1:4 mole ratio of KH₂PO₄ to ethylene oxide monomer unit was achieved. The solution mixture was cast onto a plate using an automatic doctor-blade casting machine. After drying, the separator film had a thickness of about 0.1 mm and an area of 1″×1.5″.

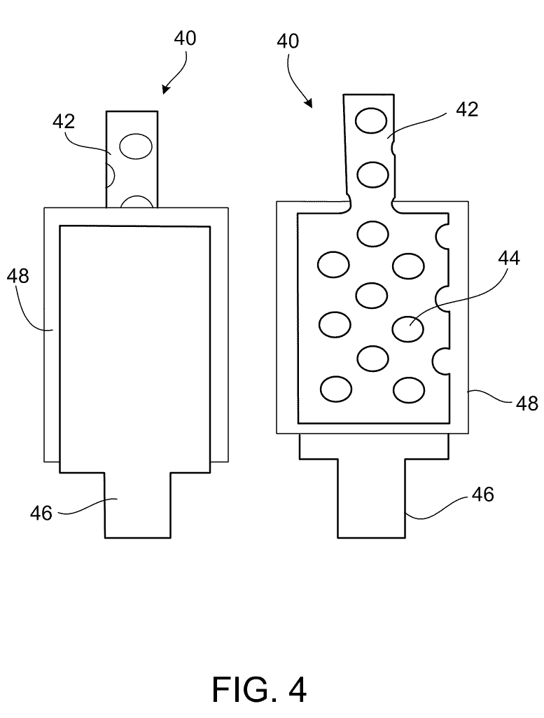

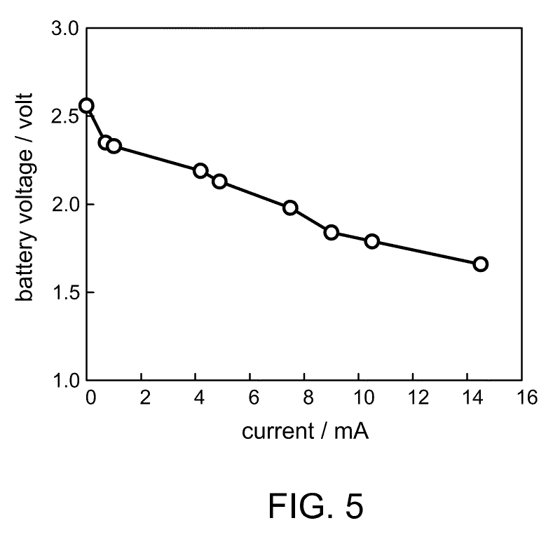

Referring to FIG. 4, the anode 42, cathode 44, and separator 46 were stacked sequentially such that the separator fully separated the anode and the cathode. The separator had a protruding edge 48 that exceeded the overlapping areas of the anode and the cathode. The cathode was oriented such that the coated layer faces outwards (not facing the separator) for maximum exposure to air. The stacked layers were then joined together by hot-pressing at about 65 degrees Celsius to afford an enclosure-less battery 40. One milliliter of a 5% NaCl solution was sprinkled onto the batteries and a steady state voltage to current measurement was conducted. The resulting curve is shown in FIG. 5.

### Example 2

### Shunt Resistor Using Enclosure-Less Battery

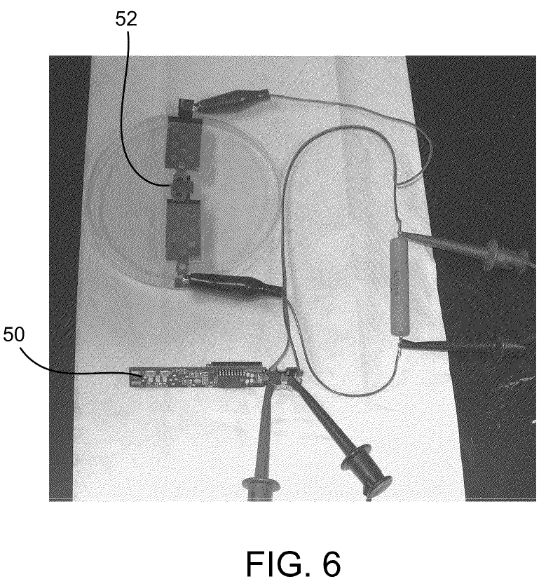

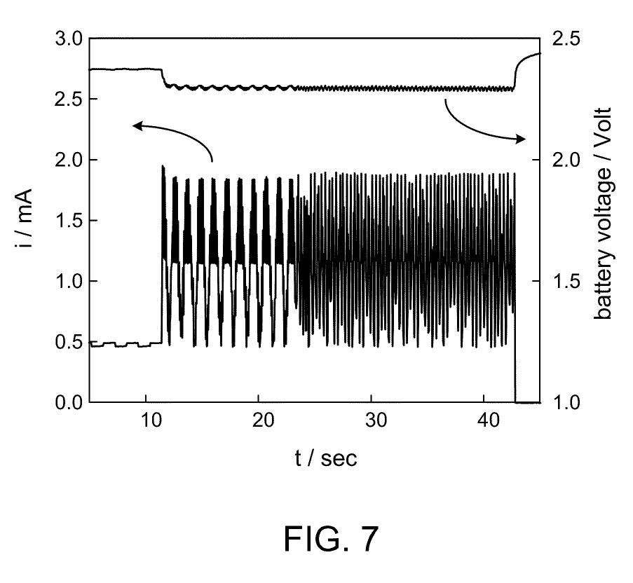

An electronic circuit 50 was obtained from a Clearblue® pregnancy test kit. The circuit was connected to a two-cell battery 52 (constructed as described in Example 1), in series as shown in FIG. 6. The battery voltage and the current using the shunt resistor of FIG. 5 were obtained and were shown in FIG. 7. As the microcontroller unit proceeded through the operation sequence, the battery maintained a near constant voltage and delivered various currents. In addition, light emitting diodes on the electronic circuit remained lit and fully functional for the duration of the measurement.

### Example 3

### Aluminum-Air Battery

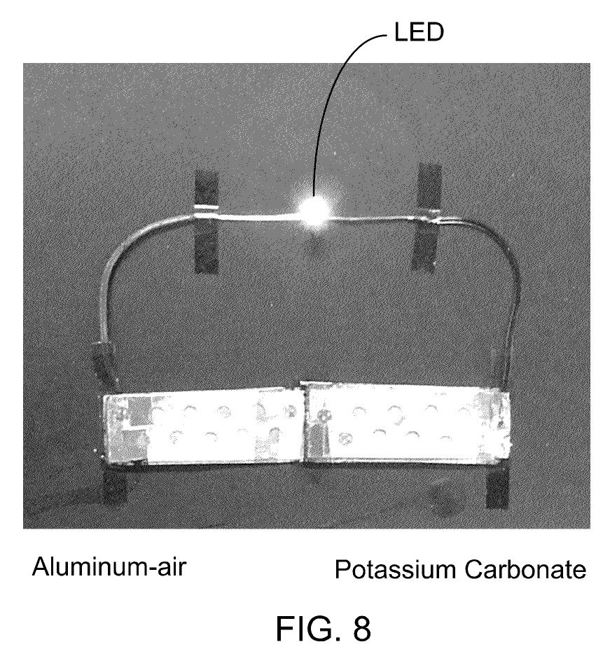

A section (1.5×3.8 cm) of a commercially available air cathode (Duracell) was cut out while retaining an attached paper separator. An aliquot of 0.5 cc 1 M aqueous potassium carbonate was dispensed on the separator and the cathode was oven dried at 110° C. for 30 min. A section of Al foil (Alcan, 0.001″) of about the same size as the cathode was cut out and perforated at a density of 3 holes/cm² with holes having ⅛″ in diameter. The Al foil was attached to the cathode and separator by taping its short-side edges with a Kapton tape (3M) to make the Al-air cells. Referring to FIG. 8, two cells were attached in series and were connected to a light emitting diode (LED). Upon dosing 1 cc of water over the perforated area, the LED lit up as shown in FIG. 8. Meanwhile, the current measured was in the range of 50-100 mA at battery voltages of 1.9-2.5 V.

### Example 4

### Zinc-Air Battery

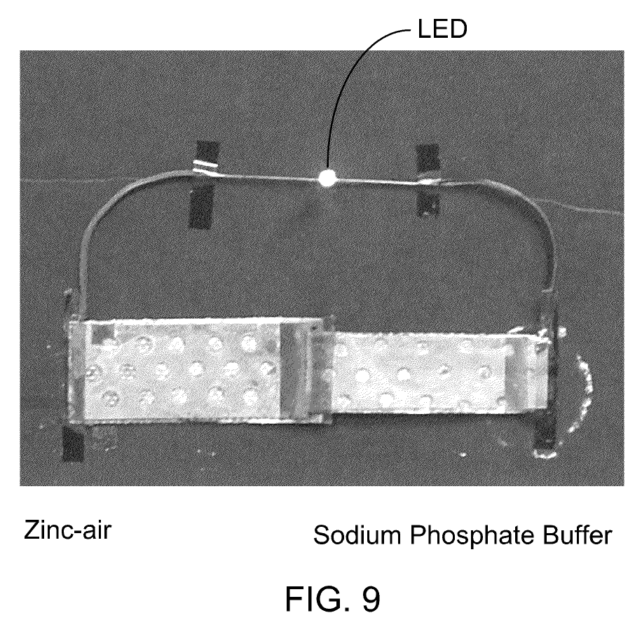

With a section of a Zn foil made as in Example 1 and a separator wetted with a sodium phosphate monobasic buffer, a battery similar to Example 3 was constructed and tested in the same way. The battery-LED assembly is shown in FIG. 9, the measured current and voltage during LED operation were about 30 mA and 2 V, respectively.

While a number of embodiments of the invention have been described, nevertheless, it will be understood that various modifications may be made without departing from the spirit and scope of the invention. For example, while a thin battery is described herein, thicker batteries are possible. Round cells, prismatic cells, where water is available slowly over a long period of time, such as days or months, are also possible.

Other embodiments are within the scope of the following claims.

What is claimed is:

1. A battery, comprising:
an anode comprising zinc, aluminum, or magnesium;
a cathode comprising at least one oxygen reduction catalyst on an electrically conducting porous substrate; and
a dry separator disposed between the anode and the cathode, comprising a hydrophilic membrane;
wherein the anode, cathode, and separator are joined together to form a layered battery, and the anode, cathode, and separator are not further enclosed within the layered battery.

2. The battery of claim 1, wherein the anode is porous.

3. The battery of claim 1, wherein the anode is perforated, woven, compressed non-woven, screened, meshed, or in the form of a foam.

4. The battery of claim 1, wherein the anode comprises a foil.

5. The battery of claim 1, wherein the anode is in direct contact with the separator.

6. The battery of claim 1, wherein the oxygen reduction catalyst is selected from the group consisting of noble metals, transition metal oxides, transition metal porphyrins, phthalocyanines, polymerized porphyrins, polymerized phthalocyanines, perovskites, cobalt salt pyrolyzed with polyacrylonitrile (Co-Pan), pyrolyzed products thereof, and combinations thereof.

7. The battery of claim 1, wherein the oxygen reduction catalyst is on one side of the porous substrate.

8. The battery of claim 1, wherein the porous substrate is selected from the group consisting of graphite, carbon black, carbon-based cloth, graphite-based cloth, and a metal screen.

9. The battery of claim 1, wherein the oxygen reduction catalyst is further supported on a material selected from the group consisting of carbon-black, graphite, charcoal, and activated carbon.

10. The battery of claim 1, wherein the porous substrate is perforated.

11. The battery of claim 1, wherein the cathode is in direct contact with the separator.

12. The battery of claim 1, wherein dry separator further comprises a salt selected from the group consisting of chloride, nitrate, sulfate, bisulfate, phosphate, phosphate monobasic, phosphate dibasic, borate, carbonate, bicarbonate, phthalate, and acetate salts of potassium, sodium, calcium, ammonium, and zinc, lithium chloride, potassium acetate, potassium nitrate, sodium nitrate, calcium chloride, potassium fluoride, zinc nitrate, potassium carbonate, and combinations thereof.

13. The battery of claim 12, wherein the salt is impregnated into the hydrophilic membrane.

14. The battery of claim 1, wherein the hydrophilic membrane comprises a material selected from the group consisting of polyethylene oxide, paper, polyacrylic acid, polyvinyl alcohol, gelatin, starch, agar, composites thereof, blends thereof, and combinations thereof.

15. The battery of claim 1, wherein the hydrophilic membrane is a free-standing film.

16. The battery of claim 1, wherein the separator has an edge sealed with a water-impermeable material.

17. The battery of claim 1, wherein the battery further comprises an adhesive disposed between the anode, the cathode, and the separator.

18. The battery of claim 17, wherein the adhesive comprises a cellulose-based hydrophilic material.

19. The battery of claim 1, wherein the battery is activated when wetted with water.

20. The battery of claim 1, wherein the battery is used in disposable or single-use devices.

21. The battery of claim 1, wherein the battery is a water detector.

22. A method of making a battery, comprising:
joining an anode comprising zinc, aluminum, or magnesium; a separator comprising a hydrophilic material and a salt; and a cathode comprising at least one oxygen reduction catalyst on a porous substrate, to provide a layered battery,
wherein the anode, cathode, and separator are not further enclosed within the layered battery.

23. The method of claim 22, wherein the hydrophilic material comprises an ion exchange membrane.

24. The method of claim 22, wherein joining comprises laminating.

25. The method of claim 22, wherein joining further comprises applying an adhesive between the anode, a separator material, and a cathode.

26. The method of claim 22, further comprising applying the oxygen reduction catalyst onto the porous substrate.

27. The method of claim 26, wherein applying includes ink-printing, painting, spraying, or spin-coating.

28. A method of using a battery, comprising:
contacting a battery including an anode comprising zinc, aluminum, or magnesium; a cathode comprising at least one oxygen reduction catalyst on a porous substrate; and a separator disposed between the anode and the cathode comprising a hydrophilic membrane and at least one salt, with a sample,
wherein the anode, cathode, and separator are joined together to form a layered battery, and the anode, cathode, and separator are not further enclosed within the layered battery.

29. The method of claim 28, wherein the sample includes water.

30. The method of claim 28, wherein the contacting the battery with the sample provides a current.

31. The method of claim 30, wherein the sample comprises a biological fluid.

32. A consumer product including a water detector, the water detector comprising:
a battery including an anode comprising zinc, aluminum, or magnesium; a cathode comprising at least one oxygen reduction catalyst on an electrically conducting porous substrate; and a dry separator disposed between the anode and the cathode, comprising a hydrophilic membrane and a salt;
wherein the anode, cathode, and separator are joined together to form a layered battery, and the anode, cathode, and separator are not further enclosed within the layered battery.

33. The consumer product of claim 32, wherein the consumer product is a diaper.

34. The consumer product of claim 32, wherein the consumer product is a pregnancy test.

35. The consumer product of claim 32, wherein the consumer product is a water detector.

36. The consumer product of claim 32, wherein the water detector further comprises a wireless communication device.
